(19) United States
(12) Patent Application Publication
(10) Pub. No.: US 2016/0066126 A1
(43) Pub. Date: Mar. 3, 2016

(54) ELECTRONIC DEVICE SYSTEM, ELECTRONIC DEVICE AND METHOD

(71) Applicant: KABUSHIKI KAISHA TOSHIBA, Tokyo (JP)

(72) Inventors: Ryo SAITO, Tokyo (JP); Jun WATANABE, Fussa Tokyo (JP)

(21) Appl. No.: 14/712,770

(22) Filed: May 14, 2015

(30) Foreign Application Priority Data
Aug. 29, 2014 (JP) 2014-175708

(51) Int. Cl. H04W 4/00; H04W 12/06; H04B 1/40

(52) U.S. Cl. CPC H04W 4/008; H04B 1/40; H04W 12/06

(57) ABSTRACT

In an embodiment, an electronic device system including an electronic device and a mobile device detachably connected to the electronic device is provided. The electronic device includes a first detector and a transceiver. The first detector is configured to detect that the mobile device is connected to the electronic device. The transceiver is configured to wirelessly communicate with the mobile device when the first detector detects that the mobile device is connected to the electronic device. The mobile device includes a controller. The controller is configured to execute a first operation when the transceiver performs the wireless communication.

### CROSS-REFERENCE TO RELATED APPLICATIONS

This application is based upon and claims the benefit of priority from Japanese Patent Application No. 2014-175708, filed Aug. 29, 2014, the entire contents of which are incorporated herein by reference.

### FIELD

Embodiments described herein relate generally to an electronic device system, an electronic device and a method.

### BACKGROUND

Recently, mobile devices such as tablet computers and smartphones have become widespread.

Along with the widespread use of these mobile devices, an electronic device called a cradle capable of easily charging (a battery provided in) such as a mobile device when the mobile device is seated therein has been developed.

Generally, when a mobile device is being charged while seated in a cradle, in many cases, the screen of the mobile device is off.

For this reason, for example, when a mobile device is seated in a cradle, it does not hold true that the mobile device is efficiently used.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of an example of an exterior appearance of a cradle of an embodiment.

FIG. 2 is a perspective view of an example of a tablet computer to be seated in the cradle.

FIG. 3 is a perspective view of an example of a state where the tablet computer is seated in the cradle.

FIG. 4 illustrates an example of a system configuration of the cradle.

FIG. 5 illustrates an example of a system configuration of the tablet computer.

FIG. 6 is a block diagram mainly showing an example of a function configuration of an electronic device system of the present embodiment.

FIG. 7 is a schematic diagram showing an example of operation of the electronic device system when the tablet computer is seated in the cradle.

FIG. 8 is a flowchart showing an example of a procedure of the electronic device system when the tablet computer is seated in the cradle.

FIG. 9 is a flowchart showing an example of a procedure of the tablet computer when the tablet computer is removed from the cradle.

FIG. 10 is a schematic diagram showing an example of operation of the electronic device system when a biopresence sensor is not provided in the cradle.

### DETAILED DESCRIPTION

Various embodiments will be described hereinafter with reference to the accompanying drawings.

In general, according to one embodiment, an electronic device system including an electronic device and a mobile device detachably connected to the electronic device is provided. The electronic device includes a first detector and a transceiver. The first detector is configured to detect that the mobile device is connected to the electronic device. The transceiver is configured to wirelessly communicate with the mobile device when the first detector detects that the mobile device is connected to the electronic device. The mobile device includes a controller. The controller is configured to execute a first operation when the transceiver performs the wireless communication.

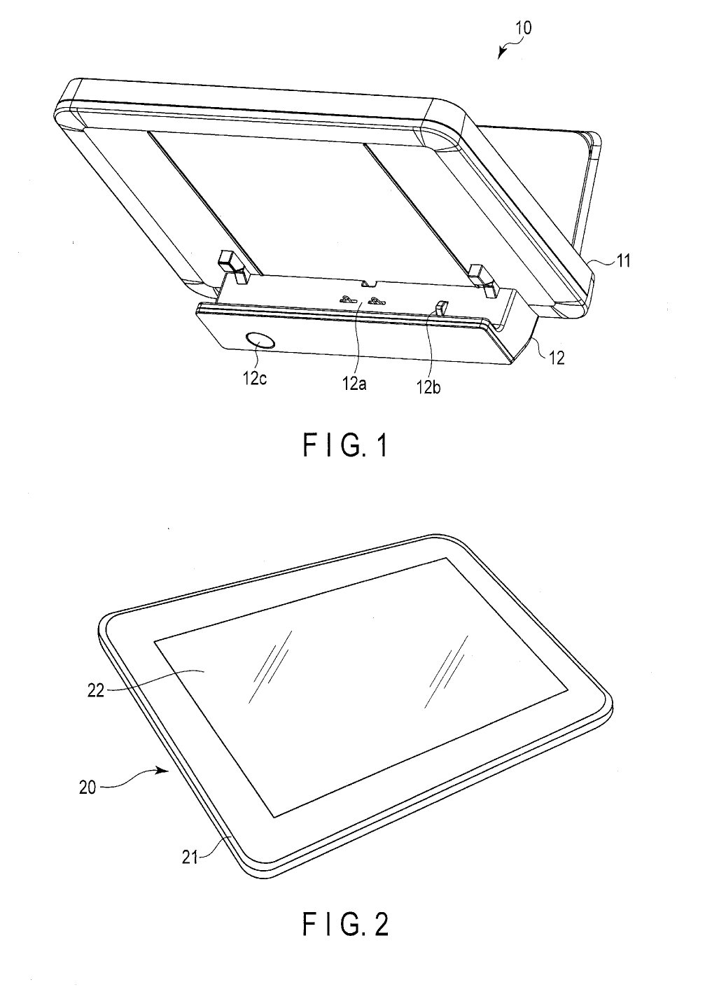

FIG. 1 is a perspective view of an example of an exterior appearance of an electronic device of the present embodiment. The electronic device of FIG. 1 is a device called, for example, a cradle. In the following descriptions, the electronic device of the present embodiment will be referred to as a cradle.

A cradle 10 of FIG. 1 is a desktop cradle designed to be placed, for example, on a table, a desk or the like. As illustrated in FIG. 1, the cradle 10 includes a rest 11 and a seat 12. With these, the cradle 10 is detachably connected to the mobile device. More specifically, the cradle 10 is configured such that the mobile device can be seated therein by placing the device in the seat 12 and propping it against the rest 11. Note that the mobile device to be seated in the cradle 10 includes, for example, a tablet computer, a smartphone, a PDA or the like. The following descriptions are given that the mobile device to be seated in the cradle 10 is a tablet computer.

Further, in the seat 12, charging contacts 12a, a switch 12b and a biopresence sensor 12c (pyroelectric sensor) are provided.

The charging contacts 12a are provided, for example, on the upper surface of the seat 12 as shown in FIG. 1, and the charging contacts 12a electrically connect the cradle 10 and the tablet computer when a tablet computer is seated in the cradle 10. In this way, it is possible to supply power from the cradle 10 to the tablet computer seated in the cradle 10, and thus the tablet computer can be charged by using the cradle 10.

The switch 12b is provided in such a position (on the upper surface of the seat 12 in the case of the example shown in FIG. 1) as to be actuated by the tablet computer when the tablet computer is seated in the cradle 10. When this switch 12b is actuated as the tablet computer is seated in the cradle 10, the cradle 10 is powered on to start the above-described charging of the tablet computer or the like.

The biopresence sensor 12c is supported, for example, on the front surface of the seat 12 as shown in FIG. 1. The biopresence sensor 12c is a sensor for detecting the presence of a person in proximity to the biopresence sensor 12c (that is, in the vicinity of the cradle 10).

Here, FIG. 2 is a perspective view of an example of the exterior appearance of a tablet computer to be seated in the cradle 10 of FIG. 1. A tablet computer 20 of FIG. 2 includes a body 21 and a touchscreen display 22.

The body 21 has a thin box-shaped housing. In the touchscreen display 22, a flat panel display and a sensor which is configured to detect a contact position of a finger or the like on the screen of the flat panel display are incorporated. The flat panel display includes, for example, an LCD or the like. The sensor includes, for example, a touchpanel or the like. In this case, a touchpanel is provided in such a manner as to cover an LCD.

Even though not shown in FIG. 2, for example, a power button for powering the tablet computer 20 on and off, a micro-USB socket and the like are provided in the side surface of the tablet computer 20. Note that, if the above-described cradle 10 is not used for charging the tablet computer 20, it is also possible to charge the tablet computer 20 by, for example, inserting the other plug (micro-USB plug) of a USB cable, one plug of which is inserted into a USB power adaptor or the like, into the micro-USB socket provided in the tablet computer 20. The USB power adaptor is an external power-supply apparatus having a USB socket.

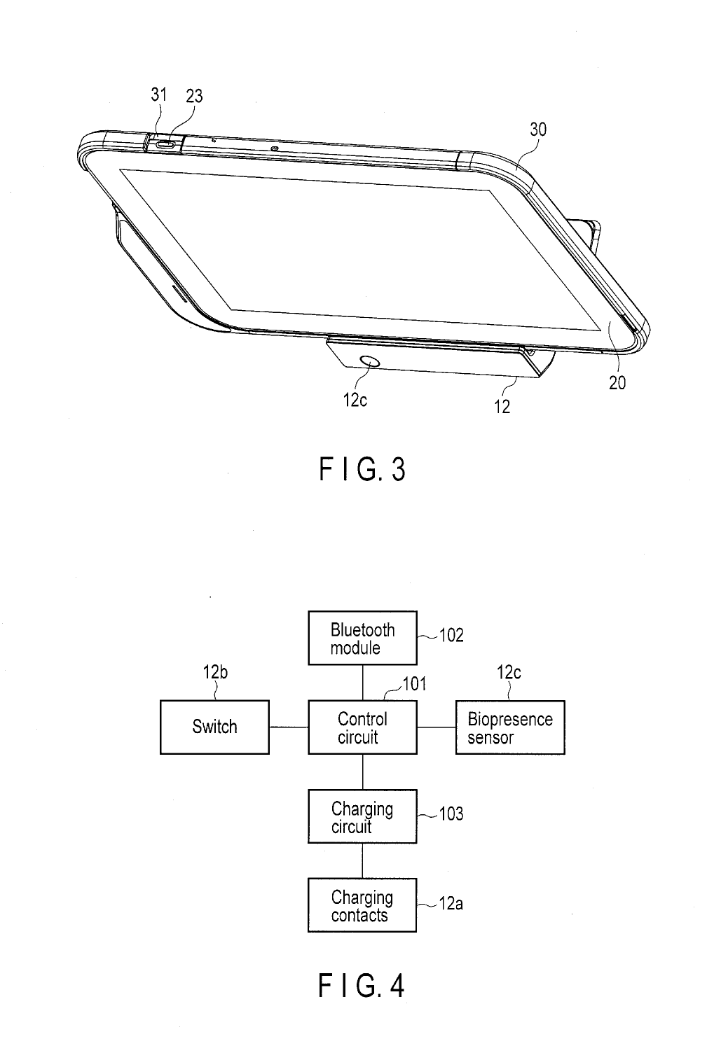

FIG. 3 is a perspective view of an example of a state where the above-described tablet computer 20 shown in FIG. 2 is seated in the cradle 10 shown in FIG. 1.

As illustrated in FIG. 3, the tablet computer 20 is seated in the cradle 10 in such a state where, for example, a cover unit 30 is attached thereto.

Although not shown in the drawing, a micro-USB plug is provided on the inner surface of the cover unit 30, and the cover unit 30 is attached in such a state where the micro-USB plug is inserted into the micro-USB socket provided in the side surface of the tablet computer 20. In this way, the tablet computer 20 and the cover unit 30 are connected with each other.

Further, on the side surface of the cover unit 30 (in a position contacting the charging contacts 12a provided in the cradle 10 when the tablet computer 20 to which the cover unit 30 is attached is seated in the cradle 10), charging contacts (not shown) are provided.

In this way, when the tablet computer 20 to which the cover unit 30 is attached is seated in the cradle 10, the charging contacts on the side surface of the cover unit 30 and the charging contacts 12a on the upper surface of the seat 12 in the cradle 10 make contact, and thus it is possible to electrically connect the cover unit 30 and the cradle 10.

That is, in the present embodiment, when the tablet computer 20 is seated in the cradle 10, the cradle 10 and the tablet computer 20 are electrically connected with each other via the cover unit 30 attached to the tablet computer 20.

By preparing the cover unit 30 for each of various kinds of tablet computers 20, it is possible to seat a tablet computer 20 of a different size, shape and the like in the cradle 10.

Here, a case where the tablet computer 20 to which the cover unit 30 is attached is seated in the cradle 10 has been described, but the tablet computer 20 may be seated directly in the cradle 10 as long as the cradle 10 and the tablet computer 20 can be electrically connected with each other when the tablet computer 20 is seated in the cradle 10.

Note that the tablet computer 20 to which the cover unit 30 is attached is seated in the cradle 10 in the present embodiment as described above, but for the sake of convenience, the following descriptions are given that the tablet computer 20 alone is seated in the cradle 10.

Further, as illustrated in FIG. 3, an opening 31 is appropriately provided in the cover unit 30. With this structure, even in a state where the cover unit 30 is attached to the tablet computer 20, it is still possible to perform an operation of a power button 23 or the like provided on the side surface of the tablet computer 20.

Note that an electronic device system of the present embodiment includes the cradle 10 (electronic device) and the tablet computer 20 (mobile device) to be seated in the cradle 10 illustrated in FIG. 3.

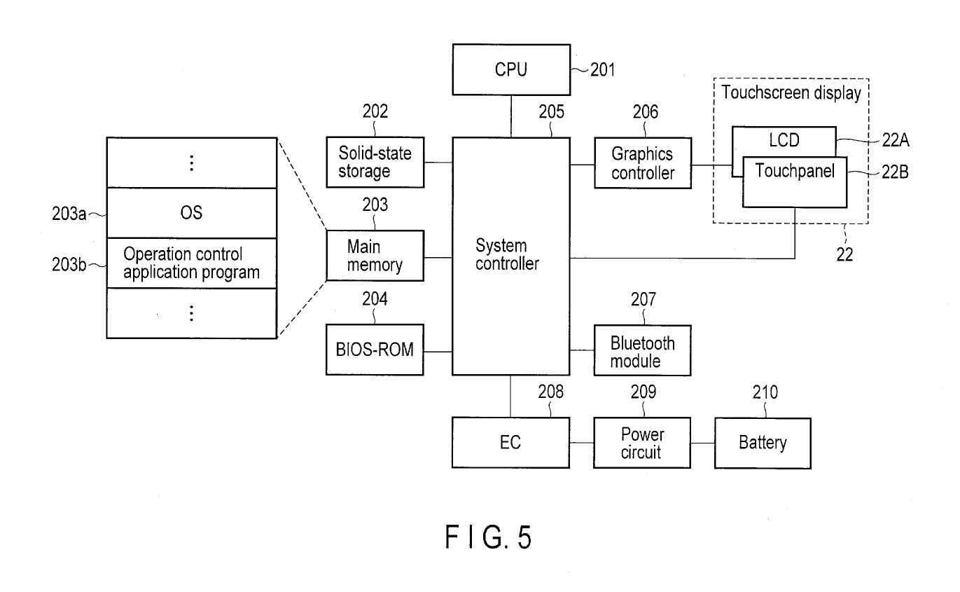

FIG. 4 illustrates an example of a system configuration of the cradle 10. As illustrated in FIG. 4, the cradle 10 includes, for example, a control circuit 101, a Bluetooth (registered trademark) module 102, a charging circuit 103 and the like in addition to the above-described charging contacts 12a, switch 12b and biopresence sensor 12c.

The control circuit 101 is configured as, for example, a single-chip microcomputer to execute various kinds of control in the cradle 10. The control circuit 101 connects to the switch 12b, the biopresence 12c, the Bluetooth module 102, the charging circuit 103 and the like.

The Bluetooth module 102 is a module configured, by means of Bluetooth, to execute a short-range wireless communication with a Bluetooth-compatible device. Note that, for example, a Bluetooth tag or the like is used as the Bluetooth module 102.

The charging circuit 103 is a circuit for charging the tablet computer 20 by, for example, supplying power supplied from an external power-supply apparatus such as a USB power adapter connected to the cradle 10 to the tablet computer 20 seated in the cradle 10. Note that power from an external power-supply apparatus is supplied to the tablet computer 20 via the charging contacts 12a.

FIG. 5 illustrates an example of a system configuration of the tablet computer 20 to be seated in the cradle 10. As illustrated in FIG. 5, the tablet computer 20 includes, for example, a CPU 201, a solid-state storage 202, a main memory 203, a BIOS-ROM 204, a system controller 205, a graphics controller 206, a Bluetooth module 207, an EC 208, a power circuit 209, a battery 201 and the like in addition to the above-described touchscreen display 22. Further, the touchscreen display 22 includes an LCD 22A and a touchpanel 22B.

The CPU 201 is a processor configured to control an operation of each component in the tablet computer 20. The CPU 201 executes various kinds of software loaded into the main memory 203 from a storage device, namely, the solid-state storage 202. The software includes an operating system (OS) 203a and various application programs. Further, the application programs include an operation control application program 203b. The operation control application program 203b has a function of controlling the operation of the tablet computer 20 when the tablet computer 20 is seated in the cradle 10, which will be described later.

The CPU 201 also executes a basic input/output system (BIOS) stored in the BIOS-ROM 204. The BIOS is a program for hardware control.

The system controller 205 is a device configured to connect a local bus of the CPU 201 and various components. The system controller 205 includes a built-in memory controller configured to perform access control of the main memory 203. The system controller 205 also includes a function of performing communication with the graphics controller 206 via a serial bus conforming to the PCI Express standard or the like.

The graphics controller 206 is a display controller configured to control the LCD 22A used as the display monitor of the tablet computer 20. The graphics controller 206 generates a display signal and transmits it to the LCD 22A. The LCD 22A displays a screen image based on the display signal. The touchpanel 22B is, for example, a capacitive pointing device for performing input on the screen of the LCD 22A. For example, a contact position touched with the user's finger on the screen, the movement of the contact position and the like are detected by the touchpanel 22B. With the touchpanel 22B, it is possible to operate a graphical user interface or the like displayed on the screen of the LCD 22A.

The Bluetooth module 207 is a module configured to execute a short-range wireless communication with a Bluetooth-compatible device by means of Bluetooth.

The EC 208 is a single-chip microcomputer including an embedded controller for power management. The EC 208 includes a function of powering the tablet computer 20 on and off based on an operation of the power button 23 by the user.

The power circuit 209 generates power to be supplied to each component in the tablet computer 20 by, for example, using power supplied from the battery 210

Note that the above-described power button 23, micro-USB socket and the like are omitted in FIG. 5.

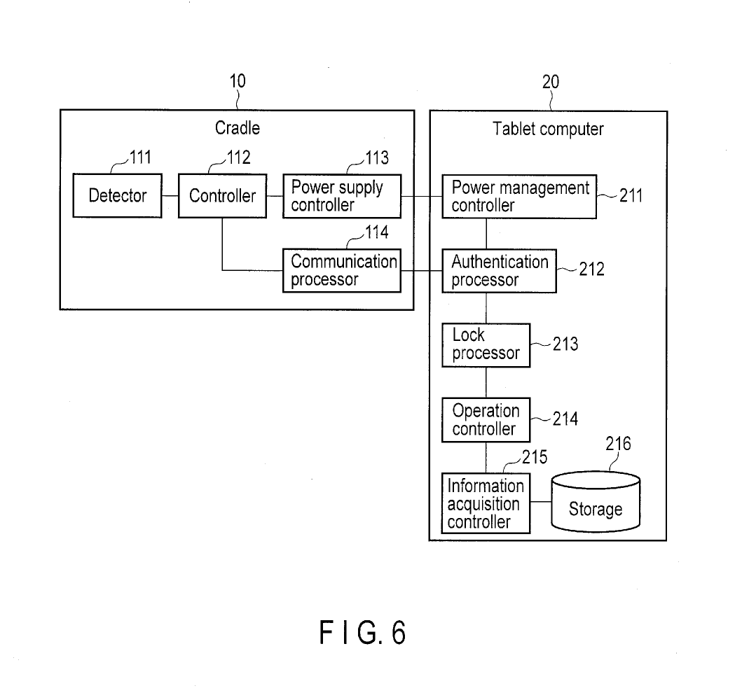

FIG. 6 is a block diagram mainly showing an example of a function configuration of the electronic device system (cradle 10 and tablet computer 20) of the present embodiment.

As illustrated in FIG. 6, the cradle 10 includes a detector 111, a controller 112, a power supply controller 113 and a communication processor (also called a transceiver) 114.

The detector 111 is a functional module realized by the biopresence sensor 12c provided in (the seat 12 provided in) the cradle 10, and detects the presence of a person in the vicinity of the cradle 10.

The controller 112 is a functional module realized by the control circuit 101 provided in the cradle 10. The controller 112 detects that the tablet computer 20 is seated in the cradle 10 when the switch 12b is actuated. When detecting that the tablet computer 20 is seated in the cradle 10, the controller 112 controls the power supply controller 113 to supply power to the tablet computer 20 for charging the battery 210 provided in the tablet computer 20.

Further, when the controller 112 detects that the tablet computer 20 is seated in the cradle 10 and the detector 111 detects the presence of a person, the controller 112 controls the communication processor 114 to execute wireless communication with the tablet computer 20.

The power supply controller 113 is a functional module realized by the charging circuit 103 provided in the above-described cradle 10, and supplies power to the tablet computer 20 based on the control by the controller 112.

The communication processor 114 is a functional module realized by the Bluetooth module 102 provided in the above-described cradle 10, and executes wireless communication (short-range wireless communication) by means of Bluetooth based on the control by the controller 112. In this case, the communication processor 114 transmits to the tablet computer 20 authentication data used by the tablet computer 20 for verification of the validity of the cradle 10.

Further, as illustrated in FIG. 6, the tablet computer 20 includes a power management controller 211, an authentication processor 212, a lock processor 213, an operation controller 214, an information acquisition controller 215 and a storage 216.

The power management controller 211 is a functional module configured to manage power supply to the entire tablet computer 20. For example, when the tablet computer 20 is seated in the cradle 10, the power management controller 211 charges the battery 210 by using power supplied by the power supply controller 113 included in the cradle 10.

The authentication processor 212 executes authentication processing of (the Bluetooth module 102 provided in) the cradle 10 by using authentication data transmitted by the communication processor 114 when wireless communication is executed by the communication processor 114 included in the cradle 10. In the authentication processing, the validity of the cradle 10 is verified.

When wireless communication with the communication processor 114 is executed as described above and if a lock (for example, a password lock) has been established in the tablet computer 20 to restrict operation of the tablet computer 20, the lock processor 213 releases the lock. Further, the lock processor 213 establishes the lock in the tablet computer 20 again (that is, the lock is reestablished) when power supply from (the power supply controller 113 included in) the cradle 10 is stopped after the lock is released (that is, when the tablet computer 20 is removed from the cradle 10).

The operation controller 214 executes a specific operation (predetermined operation) when wireless communication is executed by the communication processor 114, (that is, when the tablet computer 20 is seated in the cradle 10). Note that the specific operation executed by the operation controller 214 is set in the above-described operation control application program 203b or the like in advance. More specifically, the operation controller 214 can execute such an operation as to turn the screen of the tablet computer 20 on to display various kinds of information on the screen of the tablet computer 20.

In the above-described case of displaying information on the screen of the tablet computer 20 by the control of the operation controller 214, the information acquisition controller 215 acquires the information to be presented to the user on the screen (hereinafter referred to as presentation information). The presentation information may be stored in the storage 216 in advance or may be acquired, for example, from various external servers or the like.

Note that each functional module included in the tablet computer 20 in the present embodiment is realized, for example, when the CPU 201 executes the operation control application program 203b.

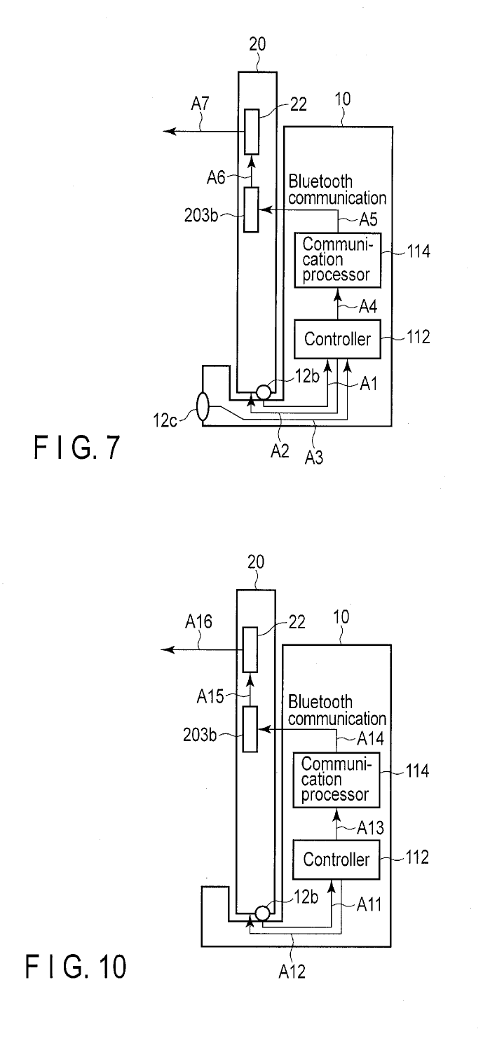

Next, an operation of the electronic device system of the present embodiment will be described. First, with reference to FIG. 7, the operation of the electronic device system executed when the tablet computer 20 is seated in the cradle 10 will be briefly described.

The following descriptions are given that such an operation as to display presentation information on the screen of the tablet computer 20 is executed in the tablet computer 20 when the tablet computer 20 is seated in the cradle 10.

First, when the switch 12b is actuated as the tablet computer 20 is seated in the cradle 10, the controller 112 included in the cradle 10 can detect that the tablet computer 20 is seated in the cradle 10 (A1).

When it is detected that the tablet computer 20 is seated in the cradle 10 in this way, based on the control of the controller 112 included in the cradle 10, power supply from the cradle 10 to the tablet computer 20 is started (A2).

When there is someone in the vicinity of the cradle 10, the presence of the person is detected by the biopresence sensor 12c (A3).

In this case, the controller 112 controls the communication processor 114 (Bluetooth module 102) (A4) to execute wireless communication (Bluetooth communication) with the tablet computer 20 by means of Bluetooth (A5). In this case, the tablet computer 20 is in a condition capable of performing wireless communication with the cradle 10 by means of Bluetooth.

When wireless communication by means of Bluetooth is executed in this way, processing for verifying the validity of the cradle 10, processing for temporarily releasing a locked state of the tablet computer 20 and the like are executed by the operation control application program 203b. Subsequently, the touchscreen display 22 provided in the tablet computer 20 (that is, the screen of the tablet computer 20) is turned on (A6) to display presentation information on the touchscreen display 22 (A7).

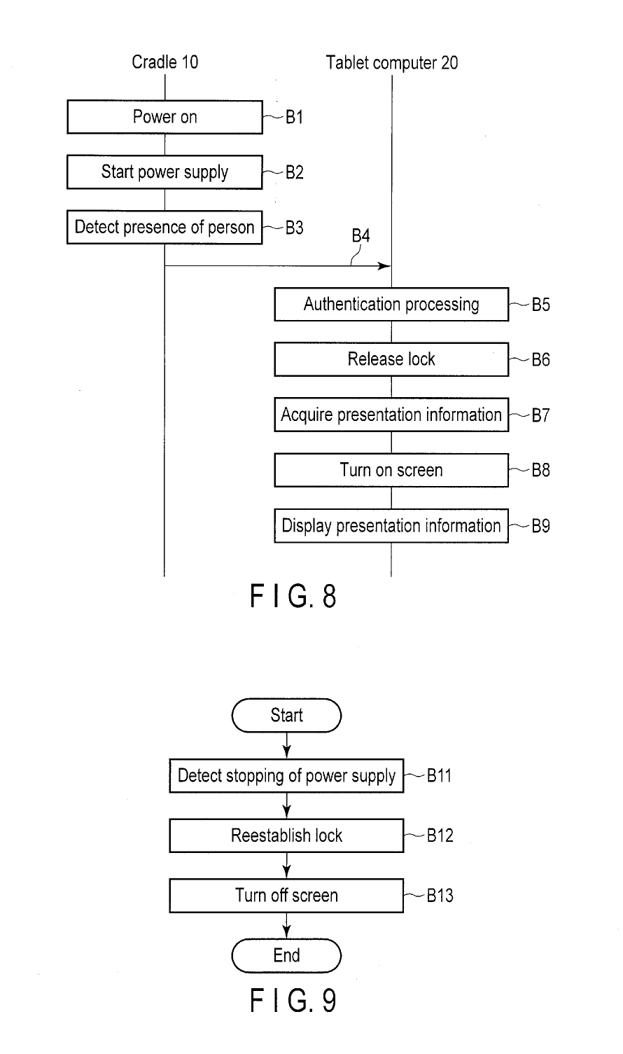

Next, with reference to the sequence chart of FIG. 8, a procedure of the electronic device system performed when the tablet computer 20 is seated in the cradle 10 will be described.

First, when the tablet computer 20 is seated in the cradle 10 as described above, the switch 12b provided (on the upper surface of the seat 12 provided) in the cradle 10 is actuated. In this case, the cradle 10 is powered on (block B1). In this way, the controller 112 included in the cradle 10 can detect that the tablet computer 20 is seated in the cradle 10.

When the cradle 10 is powered on, the controller 112 controls the power supply controller 113 to start power supply to the tablet computer 20 (block B2). In this way, charging of the battery 210 of the tablet computer 20 is started.

Here, when there is someone in the vicinity of the cradle 10, the detector 111 can detect the presence of the person by the biopresence sensor 12c (block B3).

When the presence of a person is detected by the detector 111, the controller 112 controls the communication processor 114 to execute wireless communication (short-range wireless communication) with the tablet computer 20 by means of Bluetooth (block B4). At this time, the communication processor 114 transmits, for example, an ID (data) of the Bluetooth module 102 as authentication data to the tablet computer 20.

When wireless communication by means of Bluetooth is executed by (the communication processor 114 provided in) the cradle 10 as described above, the authentication processor 212 included in the tablet computer 20 receives the authentication data transmitted by the communication processor 114 via the Bluetooth module 207. The authentication processor 212 executes processing for verifying the validity of the cradle 10 by using the received authentication data (block B5).

Here, the following descriptions are given that the ID (authentication data) of the Bluetooth module 102 provided in the cradle 10 corresponding to the tablet computer 20 is stored in the tablet computer 20 in advance. In this case, when the received authentication data coincides with the authentication data stored in the tablet computer 20 in advance, the authentication processor 212 validates (the Bluetooth module 102 provided in) the cradle 10 in which the tablet computer 20 is seated. On the other hand, when the authentication data received by the authentication processor 212 does not coincide with the authentication data stored in the tablet computer 20 in advance, the cradle 10 in which the tablet computer 20 is seated is not validated.

The following descriptions are given that the cradle 10 in which the tablet computer 20 is seated is validated by the authentication processing, but block B6 and the succeeding processing will not be executed when the cradle 10 is not validated.

Note that a case where authentication processing is executed when authentication data is received from the cradle 10 has been described, but a configuration is also possible to execute the authentication processing only when, for example, the intensity of the received signal (radio field strength) of (the short-range wireless communication by means of) Bluetooth is of a predetermined magnitude or more. In this way, it is possible to figure out the distance between the cradle 10 and the tablet computer 20, and thus it is possible to determine whether the authentication data received by the tablet computer 20 is transmitted from the cradle 10 in which the tablet computer 20 is seated or not.

When the cradle 10 in which the tablet computer 20 is seated is validated as described above, the lock processor 213 releases a lock (for example, a password lock) which has been established in the tablet computer 20 (block B6). Note that the following descriptions are given that data such as a password or the like necessary for releasing the lock is managed in the tablet computer 20. Further, in the tablet computer 20, for example, it is possible to separately establish a lock for each function of the tablet computer 20. In the present embodiment, the following descriptions are given that only the releasing of a lock necessary for displaying presentation information, which will be described later, is executed.

Here, a case where a lock is established in the tablet computer 20 has been described, but when a lock is not established in the tablet computer 20, the processing of block B6 will not be executed.

Next, the information acquisition controller 215 acquires presentation information (block B7). Here, the presentation information which is acquired by the information acquisition controller 215 includes, for example, a schedule (information) of the user of the tablet computer 20 registered in the tablet computer 20, an advertisement (information) of a company, a product, etc. and the like. Further, when an address or the like of the user are registered in the tablet computer 20, weather information or the like based on the address may be acquired as the presentation information, or information concerning traffic, crime prevention, disaster prevention and the like may be acquired as the presentation information. Still further, in order to keep an eye on a relative or the like living in a remote area, information about the relative uploaded to an external server (for example, a message from the relative, usage situations of various devices or the like which the relative is using, health information of the relative registered in the devices, and the like) may be acquired as the presentation information. Note that the presentation information is not limited to the above. Still further, the presentation information may be acquired from the storage 216 or may be acquired from an external server (cloud server) or the like.

The operation controller 214 turns the screen (touchscreen display 22) of the tablet computer 20 on (block B8).

The operation controller 214 displays presentation information which is acquired by the information acquisition controller 215 on the screen of the tablet computer 20 (block B9).

In the above-described processing of FIG. 8, it is possible to display presentation information on the screen of the tablet computer 20 when there is someone in the vicinity of the cradle 10 in which the tablet computer 20 is seated.

Next, with reference to the flowchart of FIG. 9, a procedure of the tablet computer 20 performed when the tablet computer 20 is removed from the cradle 10 will be described.

Here, the following descriptions are given that there is someone in the vicinity of the cradle 10 in which the tablet computer 20 is seated and presentation information is displayed on the screen of the tablet computer 20.

Here, for example, when the tablet computer 20 is removed from the cradle 10 by the user, the switch 12b provided (on the upper surface of the seat 12 provided) in the cradle 10 is released from a state of being actuated. In this way, the cradle 10 is powered off, and thus power supply from (the power supply controller 113 included in) the cradle 10 to the tablet computer 20 is stopped.

In this case, the power management controller 211 included in the tablet computer 20 detects that power supply from the cradle 10 is stopped (block B11).

Next, the lock processor 213 reestablishes the lock released in block B6 of FIG. 8 (block B12).

When the reestablishment of the lock is complete, the operation controller 214 turns the screen of the tablet computer 20 off (block B13).

In the above-described processing of FIG. 9, it is possible to reestablish the lock which had previously been established in the tablet computer 20 (that is, the lock which was released in block B6 shown in FIG. 8) when the tablet computer 20 is removed from the cradle 10. In this way, for example, when the user or the like tries to use the tablet computer 20 after the tablet computer 20 is removed from the cradle 10, an unlock screen (for example, a password entry screen) or the like is displayed.

As described above, in the present embodiment, the cradle 10 executes wireless communication with the tablet computer 20 when it is detected that the tablet computer 20 is seated in the cradle 10, and when wireless communication is executed, a specific operation is executed. That is, in the present embodiment, for example, even a commonly used tablet computer 20, which does not have a function of detecting that it is seated in the cradle 10, can recognize that it is seated in the cradle 10 by executing wireless communication with the cradle 10, and thus it is possible to execute a specific operation by the tablet computer 20 seated in the cradle 10. With this configuration, in the present embodiment, it is possible to use the tablet computer 20 efficiently when the tablet computer 20 is seated in the cradle 10.

Further, in the present embodiment, since the cradle 10 executes wireless communication with the tablet computer 20 when the presence of a person is detected, a specific operation can be executed when there is someone in the vicinity of the cradle 10 (and the tablet computer 20), and thus it is possible to use the tablet computer 20 more efficiently.

Still further, in the present embodiment, since the switch 12b configured to be actuated when the tablet computer 20 is seated in the cradle 10 is provided, it is possible to reliably detect that the tablet computer 20 is seated in the cradle 10.

Here, wireless communication by means of Bluetooth can generally be established in the range of a few meters to a few dozens of meters. Therefore, even if the tablet computer 20 is not seated in the cradle 10, it is possible that wireless communication by means of Bluetooth is executed with the cradle 10 and a specific operation is executed by the tablet computer 20 when the tablet computer 20 is in the range in which wireless communication by means of Bluetooth can be established. For this reason, in the present embodiment, a specific operation is executed when the intensity of a received signal of wireless communication (short-range wireless communication) by means of Bluetooth is of a predetermined magnitude or more. In this way, it is possible to prevent incorrect execution of a specific operation by the tablet computer 20 which is not seated in the cradle 10.

Note that, in the present embodiment, a case where wireless communication by means of Bluetooth is executed between the cradle 10 and the tablet computer 20 has been described, but a configuration to execute contactless communication between the cradle 10 and the tablet computer 20 is also possible in place of wireless communication by means of Bluetooth. In this case, it suffices if each of the cradle 10 and the tablet computer 20 includes a contactless communication module such as a near-field communication (NFC).

Further, in the present embodiment, if a lock has been established in the tablet computer 20 for restricting operation of the tablet computer 20, the lock will be released before a specific operation is executed. In the present embodiment, with this configuration, it is possible to execute a specific operation by the tablet computer 20 even if a lock has been established in the tablet computer 20.

Still further, in the present embodiment, when power supply from the cradle 10 is stopped after a lock is released as described above, (that is, when the tablet computer 20 is removed from the cradle 10,) the lock is reestablished in the tablet computer 20. With this configuration, in the present embodiment, even if the lock is temporarily released for executing a specific operation as described, it is possible to guarantee the security or the like of the tablet computer 20 removed from the cradle 10.

Still further, in the present embodiment, it is possible to execute a specific operation only when authentication processing for verifying the validity of the cradle 10 is executed and the tablet computer 20 is seated in the corresponding to the cradle 10. In the present embodiment, a case where authentication processing is executed in order to execute a specific operation only when the tablet computer 20 is seated in the corresponding cradle 10 has been described, but authentication processing may not be executed when verification of the validity of the cradle 10 is not needed (for example, in a case where a specific operation is also executed by the tablet computer 20 when the tablet computer 20 is seated in the cradle 10 of another user or the like).

Note that, in the present embodiment, a case where the biopresence sensor 12c is used for detecting the presence of a person has been described, but another sensor or the like may be used for detecting the present of a person.

More specifically, a configuration using a sensor capable of detecting opening and closing of the door of the room in which the cradle 10 is placed is also possible. With this configuration, when it is detected that the door is opened, this is regarded as entering of a person into the room, and thus the presence of a person can be detected. As to the detection result by the sensor in this case, it is possible to configure, for example, the cradle 10 to receive it by means of wireless communication.

Further, a sensor capable of detecting the intensity of surrounding light (that is, turning on of a light or the like) may be used. That is, when it is detected that a light is turned on, this is regarded as the presence of a person in the vicinity, and thus detection can be performed in this manner as well. Still further, it is possible to detect the presence of a person by using a sensor (for example, a microphone or the like) capable of detecting the sound of the surroundings.

Still further, in the present embodiment, a case where a sensor (for example, the biopresence sensor 12c) for detecting the presence of a person is provided in the cradle 10 has been described, but a configuration not providing the sensor is also possible.

Here, with reference to FIG. 10, an operation of the electronic device system performed when the tablet computer 20 is seated in the cradle 10 in a case where the biopresence sensor 12c is not provided in the cradle 10 will be briefly described. Note that points different from those of FIG. 7 described above will be mainly described.

First, operations A11 and A12 corresponding to A1 and A2 of FIG. 7 are performed. If the biopresence sensor 12c is not provided in the cradle 10, operation A3 shown in FIG. 7 will not be performed and operations A13 to A16 corresponding to A4 to A7 of FIG. 7 are performed.

By performing such operations in the electronic device system, even when the biopresence sensor 12c is not provided in the cradle 10, it is possible to display presentation information when the cradle 10 is seated in the cradle 10, and thus the tablet computer 20 can be efficiently used.

Note that, in the present embodiment, a case where the above-described presentation information is displayed on the screen of the tablet computer 20 when the tablet computer 20 is seated in the cradle 10 has been mainly described, but a configuration to output the presentation information, for example, vocally is also possible. Further, it suffices if the electronic device system of the present embodiment is configured to execute a specific operation by the tablet computer 20 when the tablet computer 20 is seated in the cradle 10. More specifically, when the tablet computer 20 is seated in the cradle 10, for example, it is possible to configure the tablet computer 20 to execute such an operation as to activate a specific application program installed in the tablet computer 20. Further, when the tablet computer 20 is seated in the cradle 10, it is also possible to configure the tablet computer 20 to execute such an operation as to transmit music data or the like stored in the tablet computer 20 to the cradle 10, for example, by means of wireless communication and output the music data from a speaker provided in the cradle 10 (that is, to execute such an operation as to redirect the output of data).

Further, a case where the cradle 10 of the present embodiment is a desktop cradle has been described, but in the present embodiment, it is also possible to apply, for example, a wall-hung cradle designed to be hung on a wall of a room.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An electronic device system comprising an electronic device and a mobile device detachably connected to the electronic device,
the electronic device comprising:
a first detector configured to detect that the mobile device is connected to the electronic device; and
a transceiver configured to wirelessly communicate with the mobile device when the first detector detects that the mobile device is connected to the electronic device, and
the mobile device comprising a controller configured to execute a first operation when the transceiver performs the wireless communication.

2. The electronic device system of claim 1, wherein the electronic device further comprises a second detector configured to detect whether a user is within the second detector's range, and
the transceiver is further configured to execute the wireless communication with the mobile device when the second detector detects a user.

3. The electronic device system of claim 1, wherein the first detector comprises a switch configured to be actuated when the mobile device is connected to the electronic device.

4. The electronic device system of claim 1, wherein the transceiver is further configured to execute a short-range wireless communication with the mobile device.

5. The electronic device system of claim 4, wherein the controller is configured to execute the first operation when a received signal strength of the short-range wireless communication is higher than or equal to a predetermined value.

6. The electronic device system of claim 1, wherein the mobile device further comprises a lock processor configured, if a lock has been established in the mobile device to restrict operation, to release the lock before the first operation is executed.

7. The electronic device system of claim 6, wherein
the electronic device further comprises a power supply controller configured to supply power to the mobile device when the mobile device is connected to the electronic device, and
the lock processor is further configured to reestablish the lock in the mobile device when the power supply is stopped by the power supply controller after the lock has been released.

8. The electronic device system of claim 1, wherein
the transceiver is configured to transmit authentication data to the mobile device,
the mobile device further comprises an authentication processor configured to verify validity of the electronic device based on the transmitted authentication data, and
the controller is configured to execute the first operation when the electronic device is validated.

9. An electronic device detachably connected to a mobile device, the electronic device comprising:
a first detector configured to detect that the mobile device is connected to the electronic device; and
a transceiver configured to execute wireless communication with the mobile device to execute a first operation by the mobile device when the first detector detects that the mobile device is connected to the electronic device.

10. A method executed by an electronic device system comprising an electronic device and a mobile device detachably connected to the electronic device, the method comprising:
detecting that the mobile device is connected to the electronic device;
executing wireless communication between the electronic device and the mobile device when it is detected that the mobile device is connected to the electronic device; and
executing a first operation by the mobile device when the wireless communication is executed between the electronic device and the mobile device.
